(19) United States
(12) Patent Application Publication
(10) Pub. No.: US 2015/0151990 A1
(43) Pub. Date: Jun. 4, 2015

(54) TRANSPORTATION OF FLOCCULATED TAILINGS IN A PIPELINE

(71) Applicant: SYNCRUDE CANADA LTD. in trust for the owners of the Syncrude Project, as such owners exist now and, Fort McMurray (CA)

(72) Inventors: BARRY BARA, Edmonton (CA); RANDY MIKULA, Edmonton (CA); CLARA GOMEZ, Vancouver (CA); DARWIN KIEL, New West Minister (CA); SEAN DELFEL, Vancouver (CA)

(21) Appl. No.: 14/536,110

(22) Filed: Nov. 7, 2014

Related U.S. Application Data
(60) Provisional application No. 61/903,187, filed on Nov. 12, 2013.

(51) Int. Cl. C02F 1/52; F17D 1/08; C02F 1/56; C10M 159/00

(52) U.S. Cl. CPC C02F 1/52; C10M 159/00; F17D 1/08; C02F 1/5272; C02F 1/56; C02F 1/5263; C02F 1/5236

(57) ABSTRACT

A method for transporting flocculated tailings through a pipeline is provided comprising: adding an effective amount of a flocculant or a coagulant or a combination thereof to the mining tailings to form treated mining tailings comprising tailings flocs and release water; and injecting the treated mining tailings into the pipeline at a shear rate sufficient to form a self-lubricated core-annular flow of the treated mining tailings; whereby the release water forms a protective layer around the pipeline walls thereby reducing shearing of the tailings flocs.

### FIELD OF THE INVENTION

The present invention relates to the transportation of flocculated tailings, such as flocculated oil sand fluid fine tailings, in a pipeline over substantial distances without over-shearing the flocculated material and thereby reducing the dewatering performance of the flocculated material once it is placed in a disposal area.

### BACKGROUND OF THE INVENTION

In general, tailings are the materials left over after the process of separating the valuable fraction from the non-valuable fraction of an ore. Disposal of mine tailings is one of the most important environmental issues for any mine during the project's life. In some instances, mine tailings can be disposed of in an underground mine to form backfill. However, for other mining operations, it may not be possible to dispose of the tailings in a mine and it is common practice to dispose of such tailings in ponds or lagoons, allowing the tailings to dewater naturally.

Oil sand ore is mined primarily in the Athabasca Region of Alberta, Canada. Oil sand ores are basically a combination of clay, sand, water and bitumen. Oil sand ores are mined by open pit mining and the bitumen is extracted from the mined oil sand using variations of the Clark Hot Water Process, where water is added to the mined oil sand to produce an oil sand slurry. The oil sand slurry is further processed to separate the bitumen from the rest of the components.

The oil sand extraction process produces both coarse tailings having a general particle size >44 μm and comprising primarily sand, and fine tailings having a general particle size <44 μm and comprising primarily clays. The fine tailings suspension is typically 85% water and 15% fine particles by mass. Such fine tailings are generally referred to as “fluid fine tailings” or “FFT”. “Fluid fine tailings” are a liquid suspension of oil sand fines in water with a solids content greater than 1% and having less than an undrained shear strength of 5 kPa. The fact that fluid fine tailings (FFT) behave as a fluid and have very slow consolidation rates significantly limits options to reclaim tailings ponds.

Dewatering of fine tailings occurs very slowly. When first discharged in ponds, the very low density material is referred to as thin fine tailings. After a few years when the fine tailings have reached a solids content of about 30-35%, they are referred to as mature fine tailings (MFT) which behaves as a fluid-like colloidal material. In general, “mature fine tailings” are fluid fine tailings with a low sand to fines ratio, i.e., less than about 0.3, and a solids content greater than about 30% (nominal). Unfortunately, MFT does not settle very quickly, as the clays essentially remain in suspension. It may take decades for MFT to thicken and dewater. Hence, it is desirable to be able to dewater or solidify FFT or MFT so as to be able to more economically dispose of or reclaim the fine tailings.

Recently, it has been suggested that a flocculant such as a water-soluble polymer can be added to the oil sands fine tailings to bind the fine clays together (flocculate) to form larger structures (flocs) that can be efficiently separated from the water when ultimately deposited in a deposition area. However, often the flocculated material must be transported significant distances in a pipeline to reach the designated deposition areas and, therefore, there exists a risk that the flocculated material could be over-sheared, thereby interfering in the dewatering of the tailings. Pipeline transport can break apart flocs, thereby altering their sedimentation and packing behavior.

Being able to transport agglomerated tailings longer distances without over-shearing the aggregates increases the options available for placement of tailings into a disposal area. For example, a central discharge scheme becomes more viable and allows a deposit to be formed that will have the ability to always naturally drain to the edges of the deposit.

### SUMMARY OF THE INVENTION

It was surprisingly discovered that flocculated tailings could be transported in a pipeline over long distances without over-shearing and floc break-up by using core-annular flow. In particular, a biphasic flow system is used wherein the larger structures or flocs are at the “core” (center) of the pipeline and water is the surrounding the “annulus” (walls) of the pipeline. In one aspect, tailings were optimally flocculated with a polymer, a coagulant, or both, so that large flocs are formed and enough water is released so that the water layer or annulus is naturally formed near the pipe wall. In another embodiment, water can be injected into the pipe at the surrounding annulus.

Without being bound to theory, it is believed that water forms a “lubricating” layer between the pipe wall and the flocs, allowing the flocs to move through the pipeline without over-shearing of the flocs occurring.

In one broad aspect, a method is provided for treating mining tailings and transporting treated mining tailings through a pipeline, comprising:

adding an effective amount of a flocculant or a coagulant or a combination thereof to the mining tailings to form treated mining tailings comprising tailings flocs and release water;

injecting the treated mining tailings into the pipeline at a shear rate sufficient to form a self-lubricated core-annular flow of the treated mining tailings;

whereby the release water forms a protective layer around the pipeline walls thereby reducing shearing of the tailings flocs.

In one embodiment, the shear rate is less than about 100 s⁻¹. In another embodiment, the shear rate is less than about 50 s⁻¹. In one embodiment, the mining tailings are oil sand tailings. In another embodiment, the mining tailings are fluid fine tailings. In one embodiment, the treated mining tailings are transported to centrifuges for separating the release water from the tailings flocs. The release water can be recycled for plant operations. The centrifuge cake can be placed in deposits, then capped and reclaimed.

In one embodiment, water is injected into the pipeline prior to the injection of the flocculated tailings to make the interior walls of pipeline water-wet.

It was discovered that, to establish self-lubricating core-annular flow, proper mixing of a flocculant such as a high molecular weight nonionic, anionic, or cationic polymer or a coagulant such as gypsum, lime, etc., or a combination of a flocculant and a coagulant, with tailings such as FFT, is critical to creating the proper floc structure that will dewater the tailings rapidly.

In another aspect, a method is provided for transporting flocculated tailings through a pipeline, comprising:

continuously pumping the flocculated tailings through the pipeline; and injecting a thin lubricating film of water into the pipeline on the inner wall thereof; whereby shearing of the flocculated tailings is reduced.

In one embodiment, the shear rate is reduced to less than about 50 s⁻¹. In another embodiment, drag-reducing additives such as high molecular weight polymers are added to the water. In another embodiment, the flocculated tailings are tailings that have been flocculated and then concentrated in a centrifuge or a thickener prior to pumping through the pipeline.

The present invention relates generally to a process for dewatering mining tailings produced from any mining operation, for example, coal tailings, potassium tailings, lead tailings, uranium tailings, and oil sand tailings. The composition of tailings is directly dependent on the composition of the ore and the process of mineral extraction used on the ore.

As used herein, the term “oil sand fine tailings” means tailings derived from oil sands extraction operations and containing a fines fraction. The term is meant to include fluid fine tailings (FFT), e.g., mature fine tailings (MFT) from tailings ponds and fine tailings from ongoing extraction operations (for example, thickener underflow or froth treatment tailings) which may bypass a tailings pond.

In one embodiment of the present invention, the oil sands fine tailings are primarily MFT obtained from tailings ponds. The raw MFT will generally have a solids content of around 30 to 40 wt % and may be diluted to about 20-25 wt % with water for use in the present process. However, any oil sands fine tailings having a solids content ranging from about 10 wt % to about 70 wt % or higher can be used.

As used herein, the term “flocculant” refers to a reagent which bridges the tailings particles, in particular, the fines, into larger agglomerates. Flocculants useful in the present invention are generally anionic, nonionic, cationic or amphoteric polymers, which may be naturally occurring or synthetic, having relatively high molecular weights. Preferably, the polymeric flocculants are characterized by molecular weights ranging between about 1,000 kD to about 50,000 kD. Suitable natural polymeric flocculants may be polysaccharides such as dextran, starch or guar gum. Suitable synthetic polymeric flocculants include, but are not limited to, charged or uncharged polyacrylamides, for example, a high molecular weight polyacrylamide-sodium polyacrylate co-polymer.

In one embodiment, the polymeric flocculant is a water soluble polymer having a moderate to high molecular and an intrinsic viscosity of at least about 3 dl/g (measured in 1M NaCl at 25° C.). The polymeric flocculant can be in an aqueous solution at a concentration of about between 0.05 and 5% by weight of polymeric flocculant. Typically, the polymeric flocculant solution will be used at a concentration of about 1 g/L to about 5 g/L.

Suitable doses of polymeric flocculant can range from 10 grams to 10,000 grams per tonne of oil sands fine tailings. Preferred doses range from about 400 to about 1,000 grams per tonne of oil sands fine tailings.

As used herein, the term “coagulant” refers to a reagent which neutralizes repulsive electrical charges surrounding particles to destabilize suspended solids and to cause the solids to agglomerate. Suitable coagulants include, but are not limited to, gypsum, lime, alum, polyacrylamide, or any combination thereof. In one embodiment, the coagulant comprises gypsum or lime.

As used herein, the term “shear rate” is equal to 8V/D, where V is equal to the velocity of the flocculated tailings through the pipeline (measured in meters/second) and D is the inner diameter of the pipe (measured in meters).

As used herein, “flocs” are larger-size clusters of mineral particles produced as a result of flocculation. “Flocculation” is a process of contact and adhesion of mineral particles due to the addition of a flocculant, a coagulant or a combination of a flocculant and coagulant.

### BRIEF DESCRIPTION OF THE DRAWINGS

The present invention, both as to its organization and manner of operation, may best be understood by reference to the following descriptions, and the accompanying drawings of various embodiments wherein like reference numerals are used throughout the several views, and in which:

FIG. 1 is a schematic of an embodiment of the present invention where mining tailings are fluid fine tailings obtained from an oil sand tailings pond.

FIG. 2 is a graph which plots the change in Capillary Suction Time (Delta CST (sec)) versus Shear Rate (1/sec) for well flocculated FFT.

FIG. 3 is a graph which plots the change in Capillary Suction Time (Delta CST (sec)) versus Shear Rate (1/sec) for poorly flocculated FFT due to undermixing of FFT and polymer.

FIG. 4 is a graph of Normalized Velocity (V/V_{avg}) versus Radial Position of the pipe (x/D) for well flocculated FFT and comparison to calculated values based on rheology principles.

### DETAILED DESCRIPTION OF EMBODIMENTS OF THE INVENTION

The detailed description set forth below in connection with the appended drawings is intended as a description of various embodiments of the present invention and is not intended to represent the only embodiments contemplated by the inventor. The detailed description includes specific details for the purpose of providing a comprehensive understanding of the present invention. However, it will be apparent to those skilled in the art that the present invention may be practiced without these specific details.

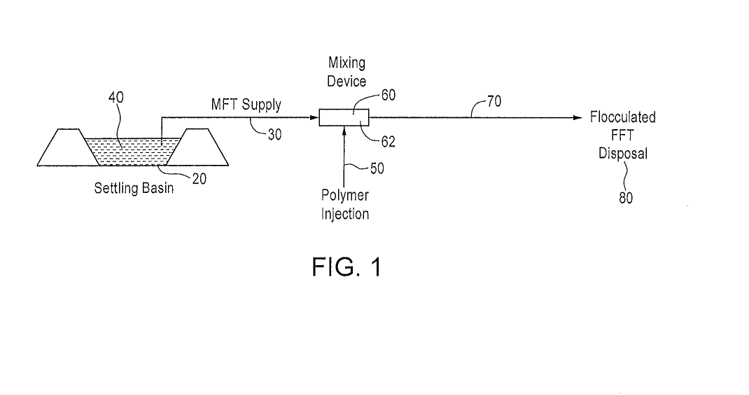

FIG. 1 is a schematic showing a process of dewatering mature fine tailings (MFT) removed from oil sand tailings settling basins or ponds 20 by using a polymer flocculant. As previously mentioned, useful flocculating polymers or “flocculants” include charged or uncharged polyacrylamides, such as a high molecular weight polyacrylamide-sodium polyacrylate co-polymer with about 25-35% anionicity. The polyacrylamide-sodium polyacrylate co-polymers may be branched or linear and have molecular weights which can exceed 20 million. In the following Examples, a branched high molecular weight polyacrylamide-sodium polyacrylate co-polymer with about 25-35% anionicity was used.

Other useful polymeric flocculants can be made by the polymerization of (meth)acryamide, N-vinyl pyrrolidone, N-vinyl formamide, N,N dimethylacrylamide, N-vinyl acetamide, N-vinylpyridine, N-vinylimidazole, isopropyl acrylamide and polyethylene glycol methacrylate, and one or more anionic monomer(s) such as acrylic acid, methacrylic acid, 2-acrylamido-2-methylpropane sulphonic acid (ATBS) and salts thereof, or one or more cationic monomer(s) such as dimethylaminoethyl acrylate (ADAME), dimethylaminoethyl methacrylate (MADAME), dimethydiallylammonium chloride (DADMAC), acrylamido propyltrimethyl ammonium chloride (APTAC) and/or methacrylamido propyltrimethyl ammonium chloride (MAPTAC).

The MFT 40 is pumped from the settling basin 20 through conduit 30 and is mixed with polymer 50, such as an aqueous solution of an acrylamide-acrylate copolymer, in mixing device 60. In one embodiment, mixing device 60 is a dynamic mixer comprising at least one impeller. Mixing device 60 can also be an in-line dynamic mixer or an in-line static mixer, as are known in the art. As used herein, “dynamic mixer” generally refers to a mixing tank or vessel having some kind of a rotary mixer (e.g., impeller) therein. As used herein, an “in-line mixer” refers to a mixing device that is installed into a pipeline through which a product flows. A “static in-line mixer” is an in-line mixer that is not powered and has no moving parts. It simply alters the flow pattern of a product by placing baffles in its path. A “dynamic in-line mixer” is usually powered by an electric motor and contains one or more mixing elements that perform a rotary motion about the axis of the flow path. During mixing, over-shearing must be prevented because over-shearing can cause the flocs to be irreversibly broken down, resulting in resuspension of the fines in the water thereby preventing water release and drying. Flocculated MFT 62 is then transported through pipeline 70 to a flocculated MFT disposal site 80.

### EXAMPLE 1

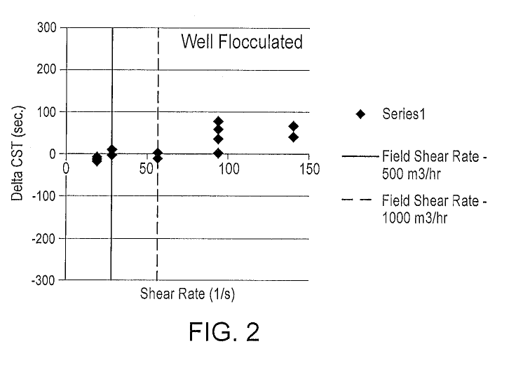

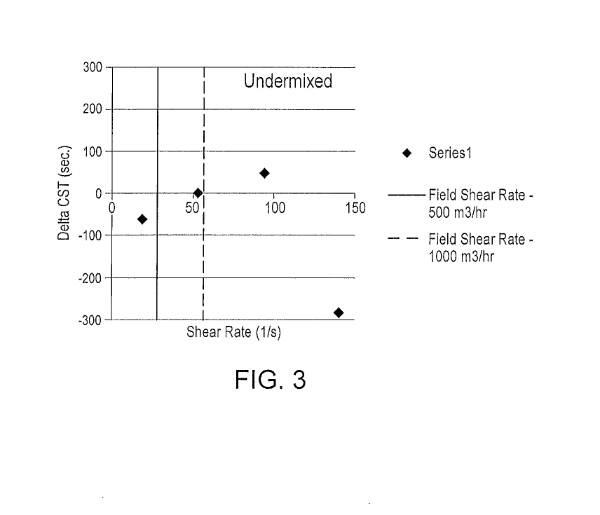

A stirred tank reactor (i.e., dynamic mixer) operated by a motor driven impeller was used in this Example. Polymer is continuously injected into the tank at polymer inlet and FFT is continuously injected at the impeller level through an FFT inlet. The flocculated FFT product is continuously withdrawn near the top of the dynamic mixer from a flocculated FFT outlet. The flocculant outlet is connected to a pipeline comprising pipe having an inner diameter of 5 cm and a length of about 30 meters. The dewatering ability of the flocculated FFT was measured using a Triton Electronics Ltd. Capillary Suction Time tester. Dewaterability is measured as a function of how long it takes for water to be suctioned through a filter and low values indicate rapid dewatering whereas high values indicate slow dewatering ability. Thus, a well flocculated FFT would have a low CST (e.g., somewhere in the order of about 20 seconds, preferably, about 10 seconds, or less) and a poorly flocculated FFT would have a high CST (e.g., higher than about 100 seconds). The polymer used in this experiment was a diluted solution (0.4 wt %) of a medium-high molecular weight (i.e., 14-20 million), branched chain anionic polymer having approximately 25-30% charge density (an acrylamide/acrylate copolymer) and the polymer dosage ranged from about 750-1000 g/tonne dry weight of tailings, unless otherwise noted. The velocity (V) of the flocculated FFT was varied (i.e., increased) to give a shear rate (1/s) from about 0 to about 150. At a commercial scale operation in a 0.4 m pipeline, a flow rate of the flocculated FFT of 500 m³/hr (the solid vertical line in FIGS. 2 and 3) or 1000 m³/hr (the dashed vertical line in FIGS. 2 and 3) would correspond to the shear rates in FIGS. 2 and 3 at 25 s⁻¹ or 50 s⁻¹. Testing at close to commercial flow rates in larger diameter pipes confirmed the small scale data shown in FIGS. 2 to 4.

One of the objectives of the following tests was to determine changes in the dewaterablity of both well flocculated FFT (properly mixed with polymer) and poorly flocculated FFT (insufficient mixing with polymer) when they are pumped through a pipeline. Little or no change in CST, i.e., a Delta CST near zero, would indicate that the flocs are not being over-sheared and that the dewatering property of the flocculated FFT has not changed as a result of being pumped through the pipeline. A change in CST will indicate that either the dewatering property of the flocculated FFT has declined, likely due to over-shearing, or that the dewatering property has improved, likely due to initial incomplete mixing of polymer and FFT followed by additional mixing in the pipeline.

With reference first to FIG. 2, well flocculated FFT having a CST of less than 20 is transported through the pipeline at increasing velocities, i.e., shear rates ranging from about 20 s⁻¹ to about 140 s⁻¹. The CST of the well flocculated FFT is measured again once the well flocculated FFT has traveled through the pipeline. The change in CST (Delta CST) is calculated by subtracting the CST before pipelining from the CST after pipelining.

It can be seen from FIG. 2 that, with well flocculated FFT, up to about a shear rate of 50 s⁻¹, there is very little change in the CST of the well flocculated FFT, i.e., ΔCST is about zero (0). However, when the shear rate is increased to about 100 s⁻¹, there is an increase in the ΔCST, due to the increase in the CST of the well flocculated FFT after pipelining versus the CST of the well flocculated FFT before pipelining. For example, if the starting CST were 20 sec, at a shear rate approaching 100 s⁻¹, the CST has increased to about 60 to about 85 sec. Thus, the dewatering ability of the initially well flocculated FFT starts to decrease after a shear rate of about 50 s⁻¹.

With reference now to FIG. 3, poorly flocculated (undermixed) FFT having a CST of about 300 to 400 is also transported through the pipeline at increasing velocities, i.e., shear rates ranging from about 20 s⁻¹ to about 140 s⁻¹. The CST of the poorly flocculated FFT is measured again once the poorly flocculated FFT has traveled through the pipeline. The change in CST (Delta CST) is calculated by subtracting the CST before pipelining from the CST after pipelining.

It can be seen from FIG. 3 that poorly flocculated FFT does not behave the same as well flocculated FFT and there is a change in CST (ΔCST) even at the lowest shear rate. It is interesting to note, however, that at high shear rate of about 140 s⁻¹, the ΔCST dropped into the negative numbers, indicating that the CST was actually decreasing when pumped through the pipeline at higher velocity. This is likely due to the continued mixing of polymer and FFT in the pipeline, which mixing was sufficient to form even stronger flocs and better dewatering. It was surprisingly discovered that the reason for the zero ΔCST for well flocculated FFT at shear rates of less than 100 s⁻¹ was that a self-lubricating water layer was being formed around the annulus of the pipe. In further testing, a portion of the pipeline was replaced with clear pipe, which allowed for visual observation of the water layer. Thus, the water layer protects the flocs from excess shear stress and therefore maintains the integrity of the flocculated tailings and preserves the dewaterability of the flocculated tailings.

### EXAMPLE 2

The self-lubrication of flocculated tailings was confirmed by comparing the measured velocity profile of a well flocculated FFT along the diameter of the pipe (normalized radial position (x/D)) with the theoretical velocity profile based on rheology, i.e., the predicted velocity based on the rheological properties of the well flocculated FFT. In this experiment, the well flocculated FFT had a CST of about 10 sec. A 2″ pipe was used and the well flocculated FFT was pumped at a rate of about 0.3 m/sec to give a shear rate in the range of 25 to 50 s⁻¹.

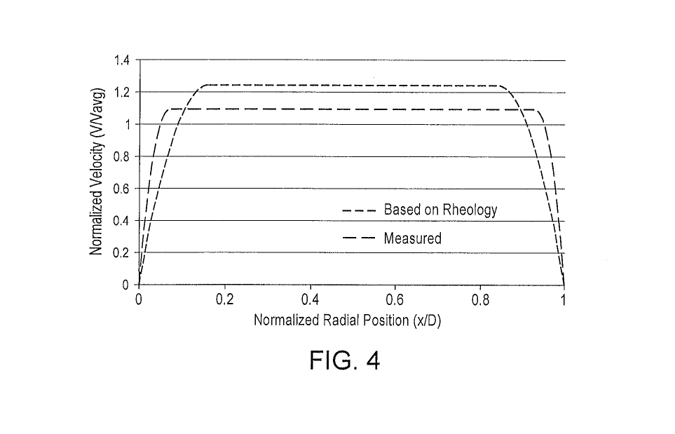

It can be seen in FIG. 4 that with well flocculated FFT (dashed line), the normalized velocity (velocity/the average velocity or V/V_{avg}) at the walls of the pipe rapidly approached 1 when compared to the theoretical profile (solid line). In other words, the actual profile was flatter that the predicted profile. This suggests that there is less viscous material at the wall of the pipe, which is consistent with the wall of the pipe being lubricated with water.

From the foregoing description, one skilled in the art can easily ascertain the essential characteristics of this invention, and without departing from the spirit and scope thereof, can make various changes and modifications of the invention to adapt it to various usages and conditions. Thus, the present invention is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims.

We claim:

1. A method for treating mining tailings and transporting treated mining tailings through a pipeline, comprising:
adding an effective amount of a flocculant or a coagulant or a combination thereof to the mining tailings to form treated mining tailings comprising tailings flocs and release water; and
injecting the treated mining tailings into the pipeline at a shear rate sufficient to form a self-lubricated core-annular flow of the treated mining tailings;
whereby the release water forms a protective layer around the pipeline walls thereby reducing shearing of the tailings flocs.

2. The method as claimed in claim 1, wherein the shear rate is less than about 100 s⁻¹.

3. The method as claimed in claim 1, wherein the shear rate is less than about 50 s⁻¹.

4. The method as claimed in claim 1, wherein the mining tailings are oil sand fine tailings.

5. The method as claimed in claim 4, wherein the mining tailings are fluid fine tailings.

6. The method as claimed in claim 1, wherein a flocculant is added comprising a high molecular weight nonionic, anionic, or cationic polymer.

7. The method as claimed in claim 1, wherein a coagulant is added selected from the group consisting of gypsum, lime, alum, polyacrylamide, or any combination thereof.

8. The method as claimed in claim 1, wherein the flocculated tailings are transported to at least one deposition cell such as an accelerated dewatering cell for dewatering.

9. The method as claimed in claim 1, wherein the flocculated tailings are spread as a thin layer onto a deposition site.

10. The method as claimed in claim 1, wherein the flocculated tailings are transported to at least one centrifuge for further separation of the release water from the tailings flocs.

11. The method as claimed in claim 1, wherein the flocculant is a charged or uncharged polyacrylamide.

12. The method as claimed in claim 1, wherein the flocculant is a high molecular weight polyacrylamide-sodium polyacrylate co-polymer with about 25-35% anionicity.

13. The method as claimed in claim 11, wherein the polyacrylamide-sodium polyacrylate co-polymers may be branched or linear and have molecular weights which can exceed 20 million.

14. The method as claimed in claim 1, wherein the flocculant has a molecular weight ranging between about 1,000 kD to about 50,000 kD.

15. The method as claimed in claim 1, wherein the flocculant is a polysaccharide such as dextran, starch or guar gum.

16. The method as claimed in claim 1, wherein the polymeric flocculant is made by the polymerization of (meth)acryamide, N-vinyl pyrrolidone, N-vinyl formamide, N,N dimethylacrylamide, N-vinyl acetamide, N-vinylpyridine, N-vinylimidazole, isopropyl acrylamide and polyethylene glycol methacrylate, and one or more anionic monomer(s) such as acrylic acid, methacrylic acid, 2-acrylamido-2-methylpropane sulphonic acid (ATBS) and salts thereof, or one or more cationic monomer(s) such as dimethylaminoethyl acrylate (ADAME), dimethylaminoethyl methacrylate (MADAME), dimethydiallylammonium chloride (DADMAC), acrylamido propyltrimethyl ammonium chloride (APTAC) and/or methacrylamido propyltrimethyl ammonium chloride (MAPTAC).

17. The method as claimed in claim 1, wherein the tailings are oil sand fine tailings have a solids content of about 10% to about 70%.

18. The method as claimed in claim 1, wherein the tailings are oil sand fine tailings have a solids content of about 15% to about 45%.

19. The method as claimed in claim 1, wherein the flocculant is in an aqueous solution at a concentration of about between 0.05 and 5% by weight of polymeric flocculant.

20. The method as claimed in claim 1, wherein the flocculant solution is used at a concentration of about 1 g/L to about 5 g/L.

21. The method as claimed in claim 1, wherein the dosage of flocculant ranges from 10 grams to 10,000 grams per tonne of mining tailings.

22. The method as claimed in claim 1, wherein the dosage of flocculant ranges from about 400 to about 1,000 grams per tonne of mining tailings.

23. The method as claimed in claim 1, wherein the mining tailings are mature fine tailings obtained from an oil sand tailings settling basin or storage pond.

24. A method for transporting flocculated tailings through a pipeline, comprising:
continuously pumping the flocculated tailings through the pipeline; and
injecting a thin lubricating film of water into the pipeline on the inner wall thereof;
whereby shearing of the flocculated tailings is reduced.

25. The method as claimed in claim 24 further comprising adding a drag-reducing agent to the water prior to injecting the water into the pipeline.

26. The method as claimed in claim 25, wherein the drag-reducing agent is a high molecular weight polymer.

27. The method as claimed in claim 24, wherein the flocculated tailings are tailings that have been flocculated with an effective amount of a flocculant or a coagulant or a combination thereof.

28. The method as claimed in claim 24, wherein the flocculated tailings are tailings that have been flocculated with an effective amount of a flocculant or a coagulant or a combination thereof and then concentrated in a centrifuge or a thickener prior to pumping through the pipeline.

29. The method as claimed in claim 24, wherein the flocculated tailings are fluid fine tailings that have been flocculated with a flocculant that is a charged or uncharged polyacrylamide.
